(19) United States
(12) Patent Application Publication
(10) Pub. No.: US 2023/0212799 A1
(43) Pub. Date: Jul. 6, 2023

(54) METHOD FOR CONSOLIDATING A FIBROUS MATERIAL WITH A BIO-BASED BINDER POLYMER, A CONSOLIDATED FIBROUS MATERIAL AND AN AQUEOUS BINDER SOLUTION

(71) Applicant: Essity Hygiene and Health Aktiebolag, Göteborg (SE)

(72) Inventors: Andrea NODBRANDT, Göteborg (SE); Anna NIHLSTRAND, Göteborg (SE); Daniel HAGBERG, Göteborg (SE); Véronique WISS, Kunheim (FR)

(73) Assignee: Essity Hygiene and Health Aktiebolag, Göteborg (SE)

(21) Appl. No.: 18/000,550

(22) PCT Filed: Jun. 1, 2021
(86) PCT No.: PCT/SE2021/050508

§ 371 Date: Dec. 2, 2022

(30) Foreign Application Priority Data
Jun. 4, 2020 (WO) PCT/SE2020/050564

(51) Int. Cl. D04H 1/587; C08L 1/28; C08K 5/092; D04H 1/64; D04H 1/425; D04H 1/732; D06M 13/188; D06M 13/192; D06M 15/09

(52) U.S. Cl. CPC D04H 1/587; C08L 1/286; C08K 5/092; D04H 1/64; D04H 1/425; D04H 1/732; D06M 13/188; D06M 13/192; D06M 15/09; D10B 2401/063; D06M 2101/06

(57) ABSTRACT

A method for consolidating a fibrous material of plant-based fibers, such as cellulose fibers and/or poly-lactic acid fibers, the method including: applying to the fibrous material an aqueous solution including a cellulose derivative, and/or a salt thereof, and an acid, the aqueous solution having a pH within the range of from 3 to 7, optionally within the range of from 3 to 6, optionally within the range of from 3 to 4.5; and drying the bonded fibrous material, optionally at 100° C. or higher. Also, a fibrous material formed by the method, an aqueous binder solution including a cellulose derivative, and/or a salt thereof, and an acid, and a nonwoven material including airlaid plant-based fibers being consolidated by a bio-based binder in the presence of a carboxylic acid, the bio-based binder being a cellulose derivative, and/or a salt thereof.

### TECHNICAL FIELD

The present disclosure pertains to a method for consolidating a fibrous material comprising or consisting of plant-based fibers. In particular, this disclosure pertains to a method for consolidating a fibrous material comprising or consisting of plant-based fibers with a bio-based binder polymer. The present disclosure also pertains to a consolidated fibrous material obtained by the method, an aqueous solution comprising a biobased binder polymer and an acid and a nonwoven material comprising fibers consolidated by the bio-based binder polymer.

### BACKGROUND OF THE INVENTION

It is common for nonwoven materials to be based on the biological raw material cellulose, the binders used to bind the fibers together and obtain the desired features are in general fossil-based polymers, making the fabric partly non-bio-based. The fossil-based polymers contribute to a material which has a high level of both wet and dry strength, water absorption capacity and other characteristics which might be of importance for its planned application. Due to the well-known and appreciated properties of the fossil-based polymers it has been difficult to find a bio-based replacement suitable to use for nonwovens. Unfortunately, an issue with moving from fossil-based binders towards bio-based ones is that the finished material in general loses some of its important characteristics, such as strength or durability.

The demands on the performance of the material will however be high and it is important that the properties of the material is not compromised with to a unreasonable extent, while a more sustainable solution still is found. It is known that water-soluble modified celluloses, such as a cellulose ethers, have many desirable qualities such as binding and water absorbing properties. However, the drawback seen with these binders is that the nonwoven material becomes quite rigid and loses much of its elongation.

In view of the above, it is an object of the present disclosure to consolidate a fibrous material by means of an environmentally friendly method, the fibrous material having maintained absorbency performance and improved mechanical strength and flexibility.

### SUMMARY OF THE INVENTION

One or more of the above objects may be achieved by a method for consolidating a fibrous material in accordance with claim 1, a fibrous material according to claim 15 consolidated by the method, an aqueous binder solution according to claim 16 and a nonwoven material according to claim 22. Further advantages and advantageous features of the invention are disclosed in the following description and in the dependent claims.

According to a first aspect, the present disclosure relates to a method for consolidating a fibrous material comprising or consisting of, plant-based fibers, such as cellulose fibers and/or poly-lactic acid (PLA) fibers, the method comprising the steps of;
applying to the fibrous material an aqueous solution comprising a cellulose derivative, and/or a salt thereof, and an acid, the aqueous solution having a pH within the range of from 3 to 7, optionally within the range of from 3 to 6, optionally within the range of from 3 and 4.5; and
drying the bonded fibrous material, optionally at 100° C. or higher.

A method of consolidating a fibrous material comprising or consisting of plant-based fibers with a bio-based binder and according to the method as disclosed herein provides a consolidated fibrous material having improved wet strength properties and maintained absorbency performance by means of an improved environmentally friendly method.

It has furthermore been found by the present inventors that by applying to the fibrous material an aqueous solution according to the present disclosure comprising a cellulose derivative, and/or a salt thereof, and an acid, the fibrous material may be consolidated without the use of additional chemicals such as for example hypophosphite and other similar agent, which is an advantage both economically and environmentally. Furthermore, since the fibrous material is not washed after the application of the aqueous solution it is an advantage to use as few chemicals as possible which does not provide benefits to the fibrous material.

Optionally the drying step may be carried out at a temperature being within a range of from 100° C. to 170° C. during a period of time of at least 2 seconds, at least 5 seconds, at least 10 seconds, at least 20 seconds, or at least 50 seconds, or at least 2 minutes, or at least 5 minutes, 10 minutes, optionally at least 15 minutes. The time of drying may depend on the drying technique used. The drying may be carried out at a temperature being within a range of from 120° C. to 160° C. during a time of at least of at least 2 seconds, at least 5 seconds, at least 10 seconds, at least 20 seconds, or at least 50 seconds, or at least 2 minutes, or at least 5 minutes, 10 minutes, optionally at least 15 minutes. The produced fibrous web may preferably have a water content of 7% or lower. The produced fibrous web may after drying preferably have a water content of 1% or lower directly after the machine, to ensure sufficient activation/curing of the binder to reach the desired tensile strength levels.

The drying step may be carried out directly after the step of applying the aqueous solution to the fibrous web.

The cellulose derivative may be carboxymethyl cellulose and the salt thereof may be sodium carboxymethyl cellulose.

The fibrous material may be an airlaid, wetlaid, foam formed, carded nonwoven or similar material comprising or consisting of plant-based fibers.

Alternatively, the fibrous material may be pre-treated with the aqueous solution, prior to a step of forming a web of material.

The acid may be a monoprotic acid.

The aqueous solution may furthermore comprise a pH control agent. To adjust the pH of the aqueous solution to the required range, for example if lower amounts of the acid is added, a pH control agent may be added to the solution.

The acid may be carboxylic acid.

The carboxylic acid may be a monocarboxylic acid, optionally lactic acid or salicylic acid. It has surprisingly been found by the present inventors that monocarboxylic acids, and in particular lactic acid and salicylic acid, provides the consolidated fibrous material with benefits in terms of improved wet strength properties by means of a method using a bio-based binder. The lactic acid may be any one of D-lactic acid, L-lactic acid or D/L lactic acid, or a blend thereof.

The carboxylic acid may be a polycarboxylic acid, i.e. having two or more carboxyl groups, optionally citric acid.

The aqueous solution may comprise one or more acids, for example a mix of monocarboxylic acids and polycarboxylic acids.

The method may comprise the step of adding a bio-based plasticizer, such as glycerol, to the fibrous material. The plasticizer may be added to the aqueous solution after dissolving the cellulose derivative in the aqueous solution and after the acid is added into the aqueous solution.

A ratio of the cellulose derivative, and/or a salt thereof, and the acid may be from 1.2:1, such as within the range of from 1.2:1 to 150:1, such as within the range of from 1.5:1 to 140:1 or within the range of from 1.7:1 to 6:1 or from 1.7:1 to 5:1. A ratio of the cellulose derivative, and/or a salt thereof, and the acid as presented herein gives the fibrous consolidated material optimum properties in terms of wet tensile strength.

The amount of acid may be within the range of from 0.01 wt-% to 3 wt-% of the aqueous binder solution total mass, optionally within the range of from 0.05 wt-% to 2 wt-% of the aqueous binder solution total mass, optionally 0.1 wt-% to 1.5 wt-% of the aqueous binder solution total mass.

The amount of cellulose derivative, and/or a salt thereof, may be within the range of from 0.4 wt-% to 6 wt-% of the aqueous binder solution total mass, optionally within the range of from 0.5 wt-% to 5 wt-% of the aqueous binder solution total mass, such as within the range of from 0.8 wt-% to 3 wt-%.

The cellulose derivative, and/or a salt thereof, may have a degree of substitution (DS) of from 0.65 to 1, optionally a DS of from 0.65 to 0.9. The cellulose derivative may be a CMC and/or a salt thereof having a DS of from 0.65 to 1, optionally a DS of from 0.65 to 0.9.

This has been found to provide a fibrous material consolidated with a bio-based binder with improved wet tensile strength. The DS of the cellulose derivative is the number of substituent groups attached per base unit. The DS may be measured by any technique known in the art. For example, the degree of substitution, including those disclosed herein, may be measured by the standard ASTM method D 1439-97 “Sodium carboxymethylcellulose” and using the Test Method A or B, depending on the type of CMC to be tested. Alternatively, the following analysis method may be used: a sample of CMC at a known weight was burned to ash, i.e. heated for 45 minutes at 650° C., then cooled to 25° C.; the cooled sample was then dissolved in distilled water having a temperature of 80° C. to form a sample mixture; the sample mixture was then cooled to 70° C., and thereafter titrated by 0.1N sulphuric acid by using methyl red as the indicator. The degree of substitution (DS) is calculated by the following formula, where b is the amount of acid consumption (mL) and G is the weight of the sample (grams):

$$Degree of Substitution ( DS ) = \frac{0.162 \times 0.1 ( \frac{b}{G} )}{1 - ( 0.08 \times 0.1 ( \frac{b}{G} ) )}$$

The aqueous solution may be applied by spraying. The aqueous solution may alternatively be applied by coating. The aqueous solution may be added to/mixed with a fiber mix of plant-based fibers prior to forming a material web or after a material web has been formed.

The present disclosure relates according to a second aspect to a fibrous material obtained by the method according to the first aspect.

The fibrous material may be an airlaid, wetlaid, foam formed, or carded fibrous material. It may be a nonwoven material.

The fibrous material may comprise one or several types of plant-based fibers, for example, the fibrous material may be a mix of cellulose fibers and PLA fibers.

According to a third aspect, the present disclosure relates to an aqueous binder solution comprising a cellulose derivative, and/or a salt thereof, and an acid, the aqueous solution having a pH within the range of from 3 to 7, optionally a pH within the range of from 3 to 6, optionally within the range of from 3 to 4.5.

The cellulose derivative may be carboxymethyl cellulose and the salt thereof may be sodium carboxymethyl cellulose.

The acid may be a carboxylic acid, optionally a monocarboxylic acid.

The aqueous solution may furthermore comprise a pH control agent.

A ratio of the cellulose derivative and the acid may be from 1.2:1, optionally within the range of from 1.2:1 to 150:1, such as within the range of from 1.5:1 to 140:1 or within the range of from 1.7:1 to 6:1 or within the range of from 1.7:1 to 5:1.

The amount of acid may be within the range of from 0.01 wt-% to 3 wt-% of the aqueous binder solution total mass, optionally within the range of from 0.05 wt-% to 2 wt-% of the aqueous binder solution total mass. Optionally, within the range of from 0.1 wt-% to 1.5 wt-% of the aqueous binder solution total mass.

The amount of cellulose derivative, and/or a salt thereof, may be within the range of from 0.4 wt-% to 6 wt-% of the aqueous binder solution total mass, optionally within the range of from 0.5 wt-% to 5 wt-% of the aqueous binder solution total mass, such as within the range of from 0.8 wt-% to 3 wt-%.

The cellulose derivative, and/or a salt thereof, may have a degree of substitution (DS) of from 0.65 to 1, optionally a degree of substitution of from 0.65 to 0.9.

According to a fourth aspect, the present disclosure relates to a nonwoven material comprising plant-based fibers, the plant-based fibers being consolidated together by a bio-based binder polymer in the presence of a carboxylic acid, the bio-based binder polymer being a cellulose derivative, and/or a salt thereof, such as carboxymethyl cellulose or a salt thereof, bonded with, the nonwoven having a wet maximum tensile strength in machine direction (MD) of 100 N/m or more, and wet maximum tensile strength in cross direction (CD) of 100 N/m or more, as measured according to NWSP 110.4R0 (15).

According to a fifth aspect, the present disclosure relates to a nonwoven material comprising plant-based fibers, the plant-based fibers being consolidated together by a bio-based binder polymer in the presence of a carboxylic acid, the bio-based binder polymer being a cellulose derivative, and/or a salt thereof, such as carboxymethyl cellulose and/or a salt thereof, wherein the nonwoven has a pH within the range of from 3.5 to 5.5, as measured with the method, as disclosed herein.

The fibers may be plant-based or manmade cellulosic fibers or polylactic acid (PLA) fibers. Cellulose fibers include viscose and lyocell fibers and the nonwoven material may include one or more types of the fibers, such as a mix of plant-based fibers. Examples of plant-based fibers are cellulose pulp fibers, cotton, kapok, and milkweed; leaf fibres, e.g. sisal, abaca, pineapple, and New Zealand hemp; or bast fibres e g flax, hemp, jute and kenaf.

The term “cellulose pulp fibres” as used herein comprises pulp fibres from chemical pulp, e.g. kraft, sulphate or sulphite, mechanical pulp, thermo-mechanical pulp, chemo-mechanical pulp and/or chemo-thermo-mechanical pulp, abbreviated as CTMP. Pulps derived from both deciduous (hardwood) and coniferous (softwood) may be used. Fibres may also come from non-wood plants, e.g. cereal straws, bamboo, jute or sisal. The fibres or a portion of the fibres may be recycled fibres, which may belong to any or all of the above categories.

The fibers may be fibrillated fibers were the fibers directly from raw material is subdued to a process aimed at obtaining individual fibers. This can be done mechanically (carding, refining) and/or with the aid of temperature and/or chemicals (eg pulp such as TMP, CTMP, BCTMP, Kraft, etc.). Then on the other hand the fibers might be regenerated cellulose or PLA, were one might produce continuous filaments from a spin dye.

The nonwoven material may have an elongation in machine direction (MD) of at least 6%, optionally at least 7%, and an elongation in cross direction (CD) of at least 6%, optionally at least 7%, as measured according to NWSP 110.4R0 (15).

The nonwoven material may be an airlaid nonwoven material.

The cellulose derivative may be carboxymethyl cellulose or a salt thereof, optionally sodium carboxymethyl cellulose.

The carboxylic acid may be a monocarboxylic acid or a polycarboxylic acid, for example citric acid.

Nonwoven material is defined as a web or sheet of fibers which are bonded together thermally, mechanically or chemically thus they are not knitted nor woven, unlike textile fabrics. The appearance and characteristics of the nonwoven can be very different, depending on the choice of raw materials as well as production process and every nonwoven is designed for a specific application. Even though the properties of the fabric may differ, it is common to use a nonwoven which has absorbent, strong, elongated and durable properties.

The manufacturing of a nonwoven begins with the arrangement of fibres into a web structure. This arrangement can be performed in different ways, some possible methods are airlaid, wetlaid and spunlaid web formation among others. There is also a wide range of different plant-based fibers that may be used and they can be either synthetic or natural fibers, such as synthetic or natural cellulosic fibers and/or polylactic acid fibers.

As the web formation on its own has limited strength it is necessary to consolidate it and bind the fibers together to enhance its strength. This can be done through thermal, mechanical or chemical bonding, and once again the choice of method depends on the desirable properties for the end-product. When bonding the web thermally the thermoplastic properties of synthetic fibers are utilized to form bonds under heating. The synthetic fibers can either be the web fibre itself or components added to the web for the sole purpose of binding the web together. In mechanical bonding the fibres are physically bonded with each other through inter-fibre friction which is achieved through needlepunching or hydroentanglement.

When the web is instead consolidated through chemical bonding, special binders are added to generate formation of bonds. There are different methods of applying the binders to the web including spraying, coating or impregnating. Commonly, the binders used in commercial products are fossil-based polymers produced through emulsion polymerisation, often referred to as latex binders. However, as the interest in producing more sustainable nonwoven materials is growing so is the investigation and applications of bio-based and biodegradable binders. There are currently however few bio-based commercial options available.

Not only do the different fibers, web forming methods and bonding methods affect the final properties but it is also possible to further customize the fabric with finishing treatments. For certain nonwoven materials the water absorbing property is a key parameter. However, it is also important with good wet and dry tensile strength, appropriate elongation and a suitable basis weight. To obtain these desirable characteristics the chemically bonded nonwoven may contain some sort of fossil-based polymer which has well documented effects on the tensile strength of the material. When now shifting focus from the fossil-based polymers in an effort to find a biodegradable replacement one large challenge is to find a biodegradable binder which still contributes to a strong and durable end-material.

Cellulose ethers are important and highly commercial cellulose derivatives. The most significant characteristic of cellulose ethers is that they are well soluble in water, but most of them are also nontoxic and odor- and tasteless making them appropriate for food and skin contact. However, they are also used as solution thickeners, binders and film formers in paint, building material and textiles. Furthermore, the moisture absorbent properties of cellulose ethers have been utilized in the area of superabsorbent material.

Commercially, the most important cellulose ether is the anionic ether carboxymethyl cellulose (CMC). Due to its anionic nature CMC is easily soluble in water already at low DS. When carboxymethylation is performed on cellulosic fibres the fibres obtain enhanced hydrophilic properties as well as a high bonding strength. The enhanced hydrophilic properties contribute to greater plasticity, meaning it gains a greater flexibility, and increased bond area as well. It is common to use CMC in its sodium form. Other important cellulose ethers are methyl or ethyl cellulose, hydroxypropyl methyl cellulose (HPMC) and hydroxyethyl cellulose (HEC). HEC has similar properties as CMC and is, just like CMC, currently used for applications such as preparations for superabsorbent materials.

### BRIEF DESCRIPTION OF THE DRAWINGS

FIG. 1 shows a graph comparing the wet and dry tensile strength of a consolidated fibrous material according to the present invention with different ratios of CMC and acid;

FIG. 2 shows a graph comparing the wet tensile strength of a consolidated fibrous material according to the present invention with different pH;

FIG. 3 shows a graph comparing the wet tensile strength of a consolidated fibrous material according to the present invention with different pH reached by CMC/acid ratio;

FIG. 4 shows a graph comparing the wet tensile strength of a consolidated fibrous material according to the present invention with different pH reached by pH adjustment by HCl or NaOH;

FIG. 5 shows a graph comparing surface pH measured on consolidated fibrous materials according to the present invention;

FIG. 6 shows a graph illustrating a comparison of dry and wet tensile strength of a fibrous material consolidated with hydroxyethyl cellulose (HEC) and citric acid (CA) in two different HEC/CA ratio's;

FIG. 7 shows a graph illustrating a comparison of dry and wet elongation of a fibrous material consolidated with HEC and citric acid in two different HEC/CA ratio's;

FIG. 8 shows a graph illustrating a comparison of dry and wet tensile strength of a fibrous material consolidated with two different cellulose derivatives and an acid and with different cellulose derivatives/acid ratio's;

FIG. 9 shows a graph illustrating a comparison of dry and wet elongation of a fibrous material consolidated with different cellulose derivatives and with different cellulose derivative/acid ratio's; and

FIG. 10 shows a graph illustrating a comparison of dry and wet tensile strength of a fibrous material consolidated with CMC and CA with different CMC/CA ratio's.

### DETAILED DESCRIPTION

### Experimental Section

Following section will describe the experimental part including equipment, chemicals and laboratory methods. A detailed description of physical testing on material properties will be included as well.

### Equipment and Material

The equipment used for laboratory testing is listed below;
A pH meter of the brand VWR sympHony was used for measuring the pH of the binder solutions.
A manual spray equipment of the brand Walther Pilot was used for spraying of the binder solutions.
For measuring the thickness of the materials, a thickness gauge of the brand Mitutoyo was used.
A tensile tester of the brand LLOYD LS1 was used for measuring wet and dry tensile strength.

### Materials and Chemicals

The CMC material used as binder in the nonwoven materials is from Sigma Aldrich and is sodium CMC, supplier reference C9481. It has a viscosity within the range of from 400 cps to 800 cps, a DS of from 0.65 to 0.9 and a sodium content of from 6.5% to 9.5%.

EVA; Ethylene-Vinyl Acetate; aqueous copolymer dispersion based on vinyl acetate and ethylene; grade name; Vinamul Elite 25; supplier: Celanese.

HEC; Hydroxy-Ethyl-Cellulose; grade name; Natrasol™ 250LR; supplier Ashland.

Glycerol (purity>=99%); Analytical reagent grade; CAS Number 56-81-5; supplier; Fisher Scientific.

CA; Citric Acid; CAS Number 77-92-9; supplier Alfa Aesar.

Lactic Acid, 85%, ACS reagent ACROS Organics, (2-hydroxypropionic acid, DL-Lactic acid); CAS Number 50-21-5, supplier Fisher scientific

SA; Salicylic acid (2-Hydroxybenzoic acid), >=99.0%; CAS Number 69-72-7, Sigma Aldrich (product number 84210)

HCl; Hydrochloric acid; CAS Number 7647-01-0; 32-38% solution; supplier Fisher Scientific

NaOH; Sodium hydroxide; CAS Number 1310-73-2; supplier Fisher Scientific

### Nonwoven Material

Throughout the description all testing will be performed on a nonwoven cloth based on cellulose fibers derived from wood. The nonwoven cloths are produced by airlaid web formation and have no additives beyond the basic cellulosic fibres. The size of each unbonded airlaid nonwoven cloth is 250×340 mm.

The combinations of substances, dry content in solution, pH of spraying solution and add-on are presented in the tables below. As reference binder an EVA binder is used.

### Preparation of the Aqueous Solutions

The aqueous solutions were prepared according to details in the tables below. To enable dissolution of the cellulose derivative, the solutions were stirred in a magnetic stirrer for at least 4 hours. The glycerol and the acid are added before the spraying. The pH of the aqueous solutions was measured. Some of the aqueous solutions were thereafter adjusted by either HCl or NaOH to reach a specified pH as illustrated in the tables.

### Spraying and Drying of the Aqueous Solution

The mixed final aqueous solutions are added to a manual spraying equipment. 20 g of the mixed aqueous solution is added per nonwoven cloth. The nonwoven cloth is placed on a steel tray with cavities which is placed in a fume cupboard. The cloth and the tray may be angled or leaned against the wall of the fume cupboard to provide optimum spraying range. Thus, it is of importance to ensure that the cloth is properly fixed to the tray, perhaps with help of clamps or the like. The cloth is then evenly sprayed with binder solution at one side on a distance of about 10 cm, and dried in an oven directly afterwards for 15 minutes at 150° C. After drying for 15 minutes the procedure is repeated for the remaining side of the cloth. The mass of spraying solution should be approximately 10 g per side of each cloth.

### Measurement of pH-Level in the Aqueous Solution

The pH-levels of selected samples of binder combinations are measured with a pH-meter of the brand VWR SympHony. An electrode is rinsed with de-ionized water and then placed in a small beaker containing the binder mixture. The electrode is kept still until the display stops blinking and the final pH-value is logged.

### Measurement of pH Level on Nonwoven Sample

Nonwoven materials of the same type as used in all experiments were cut in pieces of 5×5 cm. The material piece to be tested was placed on a plate. Then, 1 ml of 0.9% NaCl was added onto the nonwoven material. The pH was then measured directly on the nonwoven surface with a flat pH electrode. The pH value was measured at three different points and later reported as an average of the three points.

### Thickness and Basis Weight

The basis weight is measured by weighing the cloth on a scale giving the results in gram. The results are then recalculated by adding the dimensions of the cloth and presented in g/m2. This is done on all cloths from each sample. The thickness is measured by means of a measuring foot with a fixed load which is lowered onto the sample. The thickness is read off at the digital thickness gauge. The pressure plate gives a static load of 0.5 kPa. These measurements are repeated 5 times for different part of each cloth and the results are given in millimeters.

### Dry and Wet Tensile Strength

The EDANA standard method NWSP 110.4R0 (15) “Breaking Force and Elongation of Nonwoven Materials” (Strip Method) is used for measuring tensile strength and elongation. The type of specimen is according to Option B—50 mm strip tensile and with the Style of tensile testing machine option a) i.e. a Constant-rate-of-extension (CRE). The clamping distance is 100 mm, instead of 200 mm according to the standard method.

Measurements are performed on 5 dry pieces of each sample in machine direction (MD) and 5 pieces of each sample in cross direction (CD). Furthermore, measurements are also conducted on wet samples as well. For the wet testing one sample is soaked in water just before stretching to rupture/break at a constant rate of elongation. The tensile strength will record as a function of the elongation at this measurement as well. From received data, the parameters are calculated. As for dry testing, wet testing is conducted for 5 pieces of each samples in both MD and CD direction.

### Water Absorption Time and Capacity

To determine the water absorption time and the water absorption capacity of the nonwoven, a basket immersion method is used. Measurements were performed according to ISO EN 12625-8. A test piece of defined width and total mass is placed in a cylindrical basket which is dropped from 2.5+/−0.5 cm above a water surface. The time is measured from when the basket is dropped until the test piece has been fully wetted and the results serve as water absorption time. The amount of absorbed water is determined from the dry and wet weight of the test piece.

### Binder Add-on

The binder solutions (aqueous solutions) are prepared and sprayed upon the nonwoven fabric as described above. The binder add-on is shown both as the mass of the CMC and the carboxylic acid in the binder solution, as well as the percentage these components represent of the total weight of the treated nonwoven.

The add-on in percentage is calculated through the equation below.

$$a = \frac{{d}_{1} or {d}_{2}}{{m}_{dry} + {d}_{1} + {d}_{2}} \times 100$$

Where a is the add-on of the respective component, d₁ represents the dry add-on of cellulose derivative and d₂ represents the dry add-on of carboxylic acid and m_{dry} is the mass of the dry samples before spraying.

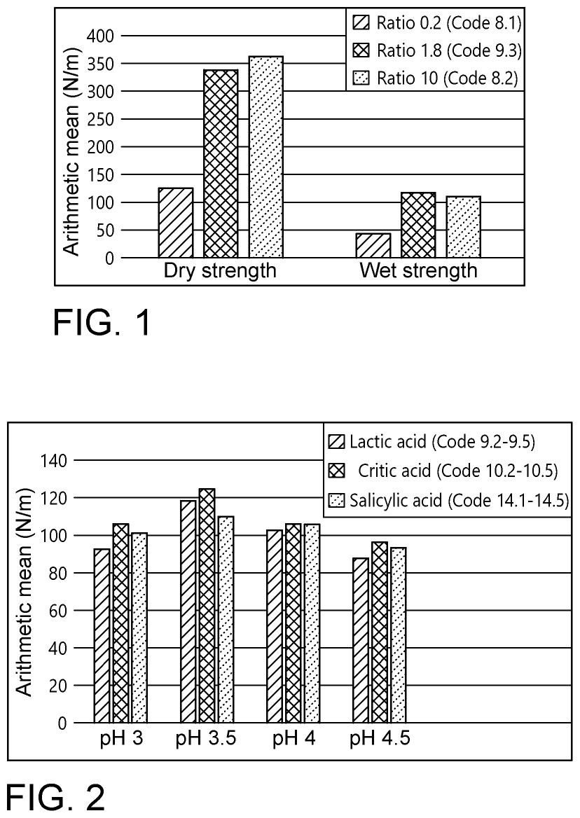

FIGS. 1-4 illustrate comparisons of the wet and/or dry tensile strength of samples of nonwoven materials as disclosed above which have been consolidated according to the present disclosure. The specifics of the samples and measurements are given in table 1 below.

The aqueous solutions used for consolidating the samples are prepared by mixing the CMC and the carboxylic acid with water in specified amounts.

FIG. 1 illustrates a comparison of the wet and dry tensile strength measured on a sample fibrous material according to the present invention consolidated with different ratios of acid and CMC. A first aqueous solution added to a first fibrous material had a ratio of the CMC to the lactic acid being 0.2:1, a second aqueous solution added to a second fibrous material had a ratio of CMC to lactic acid being 1.8:1 and a third aqueous solution was added to a third fibrous material with the ratio of the CMC to the lactic acid being 10:1. The pH of the respective aqueous solutions was adjusted to 3.5 by HCl or NaOH.

As may be shown in the graph in FIG. 1, a ratio of 1.8:1 of the CMC and the lactic acid compared to a ratio of 0.2 shows more than 50% increase in the measured wet strength and more than 200% increase in dry strength. Comparing the ratios of 1.8:1 and 10:1 shows rather similar values. The best values for the wet strength could be seen at 1.8:1. This shows that it is beneficial to add the acid, here the lactic acid, in lower amounts compared to the CMC.

FIG. 2 illustrates a comparison made with nonwoven material samples consolidated with aqueous solutions with either CMC and lactic acid, CMC and citric acid or CMC and salicylic acid with respect to wet tensile strength. For each of the respective combinations, the pH was adjusted by adding different amount of the acids while keeping the CMC level at about 0.624 wt. % in the spraying solution (and the CMC add-on level at about 2.2 wt. %), giving a CMC/acid ratio of from 1.8:1 to 1.9:1. In one solution the pH was adjusted to 3, in a further solution to pH 3.5, in a still further solution the pH was adjusted to 4 and in one solution to pH 4.5. Consequently, twelve groups of fibrous material samples were consolidated with the twelve different types of aqueous solutions and then dried. The wet tensile strength of each of the resulting consolidated fibrous materials were measured and the comparison is illustrated in the graph in FIG. 2. As may be seen in the graph, each of the three combinations with lactic acid, citric acid and salicylic acid shows the highest wet strength at pH 3.5. However, each of the pH values pH 3, pH 4 and pH 4.5 shows satisfying wet strength results.

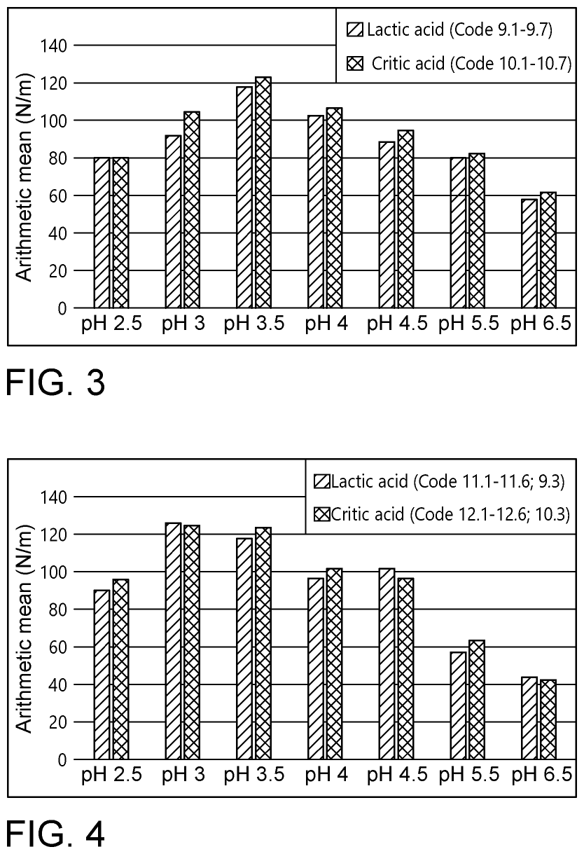

FIG. 3 illustrates further results from measurement of the wet tensile strength on nonwoven material samples having been consolidated according to the present disclosure by seven different aqueous solutions comprising CMC and citric acid or seven different aqueous solutions comprising CMC and lactic acid. For each of the respective combinations, the pH was adjusted by adding different amount of the carboxylic acids while keeping the CMC level at about 0.624 wt. % in the spraying solution (and the CMC add-on level at about 2.2 wt. %). It is clear from the results that the aqueous solutions pH values of between 3 and 4.5 have the optimal results in terms of wet tensile strength, both when the carboxylic acid is lactic acid and citric acid.

In FIG. 4, the results of a comparison of the wet tensile strength results measured for fibrous material samples having been consolidated according to the present disclosure by seven different aqueous solutions comprising CMC and citric acid or seven different aqueous solutions comprising CMC and lactic acid. The aqueous solutions used for each of the combination had a respective pH of 2.5, 3, 3.5, 4, 4.5, 5.5 or 6.5. The ratio of the CMC and the lactic acid/citric acid in each of the respective aqueous solutions were between 1.8:1-1.9:1 and the pH of the aqueous solution was instead reached by adding HCl or NaOH.

It is clear from the results that the aqueous solutions pH values of between 3 and 4.5 have the optimal results in terms of wet tensile strength, both when the carboxylic acid is the monocarboxylic acid, lactic acid and the multicarboxylic acid, citric acid. The results furthermore indicate that the presence of a crosslinking agent in form of carboxylic acid, in particular multicarboxylic acid, may not be as important as generally believed. This is supported by the fact that the wet strength decreases when the amount of carboxylic acid increases. The results furthermore clearly show that the pH is important in promoting/activating the bonding ability of the cellulose derivative, here CMC.

TABLE 1

| | | Dry content in spraying | | | | Ratio | | | | | | | | |
|---|---|---|---|---|---|---|---|---|---|---|---|---|---|---|
| | | solution [w-%] | | Add-on [%] | | Binder | pH | pH | | | Mean tensile | | Mean | |
| | Binder | Polymer | | Polymer | | polymer/ | control | spraying | Grammage | Thickness | strength [N/m] | | elongation | |
| Code | system | binder | Acid | binder | Acid | Acid | agent | solution | [g/m2] | [mm] | Dry | Wet | Dry | Wet |
| Ref | Elite 25 | 2.5 | — | 8.5 | — | — | — | 5.5 | 67.4 | 1.40 | 204 | 104 | 7.8 | 12.8 |
| 0.1 | CMC | 0.63 | — | 2.3 | — | — | — | 6.7 | 65.5 | 1.41 | 270 | 53 | 4.5 | 8.0 |
| 8.1 | CMC + | 0.625 | 3.13 | 2.0 | 9.8 | 0.2 | NaOH | 3.5 | 67.3 | 1.25 | 130 | 44 | 2.9 | 6.0 |
| | LA | | | | | | | | | | | | | |
| 8.2 | CMC + | 0.625 | 0.063 | 2.2 | 0.22 | 10 | HCl | 3.5 | 65.4 | 1.19 | 366 | 113 | 4.3 | 9.2 |
| | LA | | | | | | | | | | | | | |
| 9.1 | CMC + | 0.625 | 2.18 | 2.0 | 7.1 | 0.3 | — | 2.5 | 67.4 | 1.55 | 257 | 81 | 4.2 | 8.4 |
| | LA | | | | | | | | | | | | | |
| 9.2 | CMC + | 0.625 | 0.58 | 2.2 | 2.0 | 1.1 | — | 3.0 | 66.3 | 1.60 | 284 | 92 | 4.2 | 8.6 |
| | LA | | | | | | | | | | | | | |
| 9.3 | CMC + | 0.625 | 0.354 | 2.1 | 1.2 | 1.8 | — | 3.5 | 67.3 | 1.47 | 342 | 119 | 4.6 | 9.6 |
| | LA | | | | | | | | | | | | | |
| 9.4 | CMC + | 0.625 | 0.141 | 2.2 | 0.49 | 4.4 | — | 4.0 | 62.4 | 1.15 | 351 | 102 | 4.3 | 10.1 |
| | LA | | | | | | | | | | | | | |
| 9.5 | CMC + | 0.625 | 0.088 | 2.1 | 0.30 | 7.1 | — | 4.5 | 66.7 | 1.39 | 313 | 87 | 4.5 | 9.4 |
| | LA | | | | | | | | | | | | | |
| 9.6 | CMC + | 0.625 | 0.026 | 2.1 | 0.09 | 24 | — | 5.5 | 67.0 | 1.39 | 334 | 80 | 5.1 | 9.3 |
| | LA | | | | | | | | | | | | | |
| 9.7 | CMC + | 0.625 | 0.005 | 2.2 | 0.02 | 125 | — | 6.5 | 66.1 | 1.45 | 293 | 58 | 5.1 | 9.5 |
| | LA | | | | | | | | | | | | | |
| 10.1 | CMC + | 0.625 | 1.875 | 2.1 | 6.6 | 0.3 | — | 2.5 | 68.0 | 1.64 | 148 | 81 | 2.3 | 4.2 |
| | CA | | | | | | | | | | | | | |
| 10.2 | CMC + | 0.625 | 0.857 | 2.1 | 2.9 | 0.7 | — | 3.0 | 65.4 | 1.56 | 259 | 105 | 3.2 | 5.9 |
| | CA | | | | | | | | | | | | | |
| 10.3 | CMC + | 0.625 | 0.333 | 2.1 | 1.1 | 1.9 | — | 3.5 | 69.0 | 1.50 | 312 | 124 | 4.1 | 9.2 |
| | CA | | | | | | | | | | | | | |
| 10.4 | CMC + | 0.625 | 0.150 | 2.2 | 0.52 | 4.2 | — | 4.0 | 62.5 | 1.22 | 372 | 106 | 4.3 | 9.8 |
| | CA | | | | | | | | | | | | | |
| 10.5 | CMC + | 0.625 | 0.083 | 2.2 | 0.29 | 7.5 | — | 4.5 | 66.7 | 1.45 | 296 | 95 | 4.5 | 9.7 |
| | CA | | | | | | | | | | | | | |
| 10.6 | CMC + | 0.625 | 0.014 | 2.1 | 0.05 | 45 | — | 5.5 | 65.6 | 1.42 | 347 | 82 | 5.2 | 9.8 |
| | CA | | | | | | | | | | | | | |
| 10.7 | CMC + | 0.625 | 0.002 | 2.1 | 0.007 | 313 | — | 6.5 | 67.1 | 1.33 | 322 | 62 | 5.2 | 8.5 |
| | CA | | | | | | | | | | | | | |
| 11.1 | CMC + | 0.625 | 0.354 | 2.2 | 1.22 | 1.8 | HCl | 2.5 | 65.0 | 1.27 | 236 | 90 | 3.2 | 7.1 |
| | LA | | | | | | | | | | | | | |
| 11.2 | CMC + | 0.625 | 0.354 | 2.2 | 1.22 | 1.8 | HCl | 3.0 | 63.7 | 1.60 | 344 | 126 | 4.0 | 8.7 |
| | LA | | | | | | | | | | | | | |
| 11.3 | CMC + | 0.625 | 0.354 | 2.2 | 1.22 | 1.8 | NaOH | 4.0 | 60.8 | 1.35 | 315 | 96 | 4.8 | 9.6 |
| | LA | | | | | | | | | | | | | |
| 11.4 | CMC + | 0.625 | 0.354 | 2.2 | 1.22 | 1.8 | NaOH | 4.5 | 66.2 | 1.36 | 383 | 103 | 5.7 | 10.1 |
| | LA | | | | | | | | | | | | | |
| 11.5 | CMC + | 0.625 | 0.354 | 2.2 | 1.22 | 1.8 | NaOH | 5.5 | 67.1 | 1.39 | 365 | 56 | 6.1 | 8.0 |
| | LA | | | | | | | | | | | | | |
| 11.6 | CMC + | 0.625 | 0.354 | 2.2 | 1.22 | 1.8 | NaOH | 6.5 | 64.5 | 1.39 | 396 | 46 | 5.8 | 7.2 |
| | LA | | | | | | | | | | | | | |
| 12.1 | CMC + | 0.625 | 0.333 | 2.2 | 1.16 | 1.9 | HCl | 2.5 | 64.9 | 1.21 | 257 | 96 | 2.8 | 6.3 |
| | CA | | | | | | | | | | | | | |
| 12.2 | CMC + | 0.625 | 0.333 | 2.2 | 1.16 | 1.9 | HCl | 3.0 | 64.8 | 1.31 | 346 | 125 | 3.5 | 7.4 |
| | CA | | | | | | | | | | | | | |
| 12.3 | CMC + | 0.625 | 0.333 | 2.2 | 1.16 | 1.9 | NaOH | 4.0 | 62.6 | 1.38 | 339 | 102 | 4.7 | 10.4 |
| | CA | | | | | | | | | | | | | |
| 12.4 | CMC + | 0.625 | 0.333 | 2.2 | 1.16 | 1.9 | NaOH | 4.5 | 66.2 | 1.48 | 350 | 98 | 4.1 | 8.5 |
| | CA | | | | | | | | | | | | | |
| 12.5 | CMC + | 0.625 | 0.333 | 2.2 | 1.16 | 1.9 | NaOH | 5.5 | 65.3 | 1.63 | 327 | 63 | 4.7 | 8.4 |
| | CA | | | | | | | | | | | | | |
| 12.6 | CMC + | 0.625 | 0.333 | 2.2 | 1.16 | 1.9 | NaOH | 6.5 | 64.8 | 1.60 | 352 | 44 | 4.8 | 6.7 |
| | CA | | | | | | | | | | | | | |
| 14.1 | CMC + | 0.625 | 0.400 | 2.2 | 1.4 | 1.6 | — | 3.0 | 65.0 | 1.23 | 279 | 100 | 4.1 | 9.2 |
| | SA | | | | | | | | | | | | | |
| 14.3 | CMC + | 0.625 | 0.267 | 2.2 | 0.9 | 2.3 | — | 3.5 | 65.0 | 1.21 | 333 | 110 | 4.0 | 9.6 |
| | SA | | | | | | | | | | | | | |
| 14.4 | CMC + | 0.625 | 0.150 | 2.2 | 0.5 | 4.2 | — | 4.0 | 65.5 | 1.37 | 327 | 105 | 4.3 | 10.1 |
| | SA | | | | | | | | | | | | | |
| 14.5 | CMC + | 0.625 | 0.083 | 2.2 | 0.3 | 7.5 | — | 4.5 | 65.0 | 1.39 | 309 | 93 | 4.6 | 9.3 |
| | SA | | | | | | | | | | | | | |

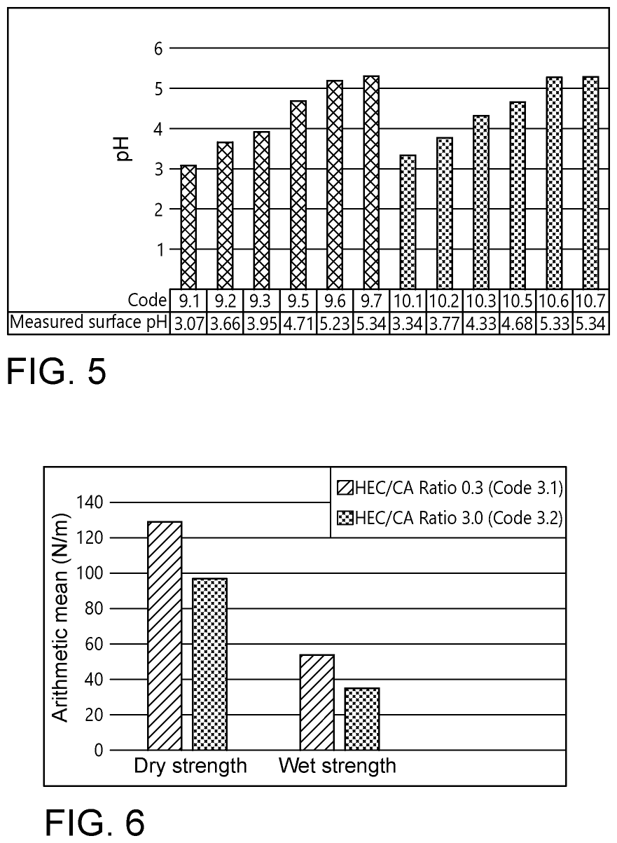

FIG. 5 shows the results of pH measurements of samples of nonwoven materials produced according to the present disclosure. The samples are nonwoven materials formed by airlaid web formation as disclosed above. The samples were consolidated by aqueous solutions either comprising CIVIC and lactic acid or an aqueous solution comprising CIVIC and citric acid. Twelve aqueous solutions were prepared, with a first batch comprising six aqueous solutions comprising CMC and citric acid and a second batch comprising six solution comprising CMC and lactic acid. The pH was adjusted in each of the solutions by adding different amounts of carboxylic acid while keeping the CMC level at about 0.624 wt. % in the spraying solution (and the CMC add-on level constant at about 2.2 wt. %). The pH of the aqueous solutions was adjusted to 2.5, 3, 3.5, 4.5, 5.5 and 6.5, for each of the batches as illustrated in table 2 below.

Five to ten samples of nonwoven materials were consolidated using each aqueous solution and the surface pH was then measured for the respective sample as disclosed above. The value illustrated in the graph is the average value of the five to ten samples in each group.

As may be seen in FIG. 5 and Table 2, an aqueous solution having a pH of 2.5 and comprising citric acid provided a nonwoven sample having a surface pH of 3.34 while the aqueous solution comprising lactic acid provided a nonwoven sample having a pH of 3.07. The aqueous solution having a pH of 3.0 and comprising citric acid provided a nonwoven sample having a surface pH of 3.77 while the aqueous solution comprising lactic acid provided a nonwoven sample having a pH of 3.66. The aqueous solution having a pH of 3.5 and comprising citric acid provided a nonwoven sample having a surface pH of 4.33 while the aqueous solution comprising lactic acid provided a nonwoven sample having a pH of 3.95. The aqueous solution having a pH of 4.5 and comprising citric acid provided a nonwoven sample having a surface pH of 4.68 while the aqueous solution comprising lactic acid provided a nonwoven sample having a pH of 4.71. The aqueous solution having a pH of 5.5 and comprising citric acid provided a nonwoven sample having a surface pH of 5.33 while the aqueous solution comprising lactic acid provided a nonwoven sample having a pH of 5.23. The aqueous solution having a pH of 6.5 and comprising citric acid provided a nonwoven sample having a surface pH of 5.34 while the aqueous solution comprising lactic acid provided a nonwoven sample having a pH of 5.34. Thus, the surface pH measured on the nonwoven sample corresponds relatively well with the pH in the respective aqueous solution. Consequently, it may be concluded that the benefits which may be provided with a nonwoven material intended to be used in contact with the skin and having a pH controlling effect may be provided with a fibrous material produced according to the present disclosure.

TABLE 2

| | | | | | Ratio | | | | | | | | | | | | |
|---|---|---|---|---|---|---|---|---|---|---|---|---|---|---|---|---|---|
| | Binder system | | Add-on [w-%] | | Binder | pH | | | | | | | | | | | |
| | Binder | | Binder | | polymer/ | spraying | Measured surface pH | | | | | | | | | | |
| Code | polymer | Acid | polymer | Acid | Acid | solution | 1 | 2 | 3 | 4 | 5 | 6 | 7 | 8 | 9 | 10 | Average |
| Ref | Elite 25 | — | 8.5 | — | — | 5.5 | 3.95 | 3.92 | 3.98 | 3.94 | 3.97 | 3.94 | 3.97 | | | | 3.95 |
| 0.1 | CMC | — | 2.3 | — | — | 6.7 | 5.08 | 5.06 | 5.20 | 5.21 | 5.17 | 5.15 | 5.13 | | | | 5.14 |
| 9.1 | CMC | LA | 2.1 | 6.6 | 0.3 | 2.5 | 3.12 | 3.07 | 3.09 | 3.07 | 3.05 | 3.03 | 3.05 | | | | 3.07 |
| 9.2 | CMC | LA | 2.1 | 2.9 | 1.1 | 3.0 | 3.65 | 3.62 | 3.70 | 3.74 | 3.60 | 3.72 | 3.61 | | | | 3.66 |
| 9.3 | CMC | LA | 2.1 | 1.1 | 1.8 | 3.5 | 3.92 | 3.85 | 3.89 | 3.95 | 3.91 | 4.13 | 4.07 | 3.93 | 3.91 | | 3.95 |
| 9.5 | CMC | LA | 2.2 | 0.29 | 7.1 | 4.5 | 4.72 | 4.74 | 4.73 | 4.68 | 4.63 | 4.62 | 4.73 | 4.76 | 4.81 | 4.68 | 4.71 |
| 9.6 | CMC | LA | 2.1 | 0.05 | 24 | 5.5 | 5.24 | 5.27 | 5.29 | 5.24 | 5.31 | 5.25 | 5.23 | 5.01 | 5.14 | 5.27 | 5.23 |
| 9.7 | CMC | LA | 2.1 | 0.007 | 125 | 6.5 | 5.36 | 5.32 | 5.29 | 5.37 | 5.42 | 5.32 | 5.32 | | | | 5.34 |
| 10.1 | CMC | CA | 2.0 | 7.1 | 0.3 | 2.5 | 3.35 | 3.39 | 3.36 | 3.30 | 3.32 | 3.33 | 3.36 | | | | 3.34 |
| 10.2 | CMC | CA | 2.2 | 2.0 | 0.7 | 3.0 | 3.65 | 3.76 | 3.80 | 3.78 | 3.78 | 3.81 | 3.80 | | | | 3.77 |
| 10.3 | CMC | CA | 2.1 | 1.2 | 1.9 | 3.5 | 4.27 | 4.34 | 4.33 | 4.38 | 4.24 | 4.38 | 4.35 | | | | 4.33 |
| 10.5 | CMC | CA | 2.1 | 0.30 | 7.5 | 4.5 | 4.68 | 4.66 | 4.65 | 4.69 | 4.69 | 4.72 | 4.70 | | | | 4.68 |
| 10.6 | CMC | CA | 2.1 | 0.09 | 45 | 5.5 | 5.31 | 5.34 | 5.32 | 5.36 | 5.29 | 5.32 | 5.34 | | | | 5.33 |
| 10.7 | CMC | CA | 2.2 | 0.02 | 313 | 6.5 | 5.35 | 5.40 | 5.07 | 5.26 | 5.39 | 5.32 | 5.41 | 5.40 | 5.38 | 5.40 | 5.34 |

FIG. 6 illustrates the results from measurements of dry and wet strength with nonwoven material samples as described above being consolidated with a binder system of HEC and CA, the ratio of the HEC/CA being 0.3:1 and 3.0:1.

FIG. 7 illustrates the results of dry and wet elongations tests being performed on nonwoven samples materials as described for FIG. 6.

When using HEC, in contrast to the results when using CMC, the material seems to gain slightly higher mechanical strength if more citric acid is used, but lower elongation, see FIGS. 6 and 7. When preparing the binder solution with HEC and citric acid it was soon clear that the viscosity of the solution was very high. Due to the high viscosity of the mixture it was hard, impossible almost, to distribute it over the nonwoven material through spraying. The solution was therefore diluted with water to half the concentration

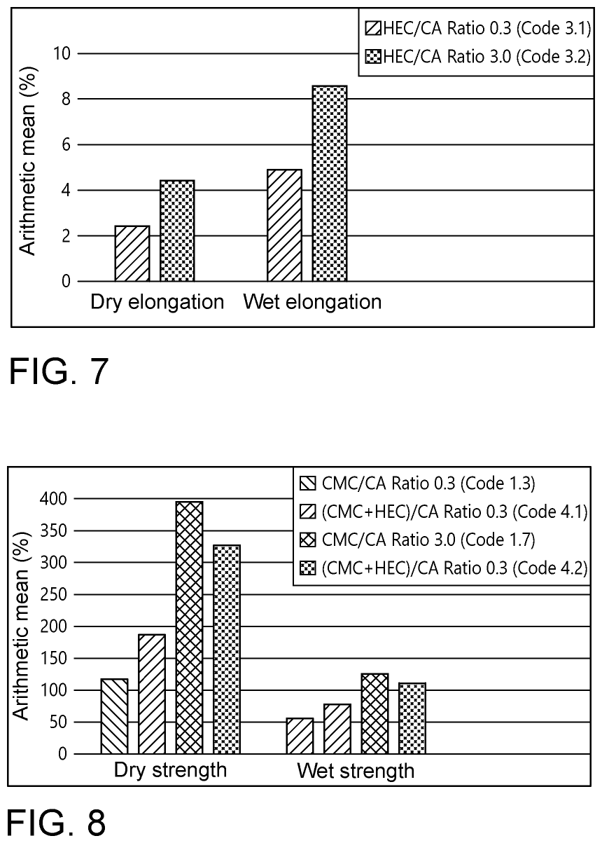

FIG. 8 illustrates the results from measurements of dry and wet strength performed on nonwoven samples as described above and with a binder system either CMC and CA or a combination of CMC and HEC in the presence of CA.

FIG. 9 illustrates the results from measurements of dry and wet elongation performed on the nonwoven samples where a comparison between HEC and HEC/CMC in combination with a high and low amount of carboxylic acid was made.

As shown in FIG. 9 and which may also be seen from the results presented in table 4 below, the elongation of the nonwoven material is surprisingly increased when the amount of carboxylic acid in the solution is decreased. This is contrary to what is seen for HEC in FIGS. 6-7 where a lower concentration of citric acid generates a higher elongation.

Details of the samples tested in FIGS. 6-9 are given in table 3 below.

TABLE 3

| | | | Dry content in spraying | | Ratio | | | | |
|---|---|---|---|---|---|---|---|---|---|
| | Binder system | | solution [w-%] | | Binder | | pH | Add-on [wt-%] | |
| | Binder | | Binder | | polymer/ | | spraying | Binder | |
| Code | polymer | Acid | polymer | Acid | Acid | Additive | solution | polymer | Acid |
| Ref | Elite 25 | — | 2.5 | — | — | — | 5.5 | 8.5 | — |
| 0.1 | CMC | — | 0.625 | — | — | — | 6.7 | 2.3 | — |
| 1.1 | CMC | CA | 1.25 | 2.5 | 0.5 | — | n.a. | 4.1 | 8.1 |
| 1.2 | CMC | CA | 1.25 | 0.625 | 2.0 | — | n.a. | 4.3 | 2.2 |
| 1.3 | CMC | CA | 0.625 | 1.875 | 0.3 | — | 2.5 | 2.2 | 6.6 |
| 1.4 | CMC | CA | 0.625 | 1.250 | 0.5 | — | n.a. | 2.3 | 4.7 |
| 1.5 | CMC | CA | 0.625 | 0.625 | 1.0 | — | n.a. | 2.4 | 2.4 |
| 1.6 | CMC | CA | 0.625 | 0.313 | 2.0 | — | n.a. | 2.4 | 1.2 |
| 1.7 | CMC | CA | 0.625 | 0.210 | 3.0 | — | 3.9 | 2.3 | 0.8 |
| 1.8 | CMC | CA | 0.625 | 1.875 | 0.3 | GLY* | n.a. | 2.3 | 6.6 |
| 1.9 | CMC | CA | 0.625 | 0.210 | 3.0 | GLY* | n.a. | 2.4 | 0.8 |
| 1.10 | CMC | CA | 0.625 | 0.210 | 3.0 | GLY ** | n.a. | 2.4 | 0.8 |
| 3.1 | HEC | CA | 0.313 | 0.938 | 0.3 | — | n.a. | 1.1 | 3.3 |
| 3.2 | HEC | CA | 0.313 | 0.105 | 3.0 | — | n.a. | 1.2 | 0.4 |
| 4.1 | CMC + HEC | CA | 0.42 + 0.21 | 1.875 | 0.3 | — | n.a. | 1.4 + 0.7 | 6.4 |
| 4.2 | CMC + HEC | CA | 0.42 + 0.21 | 0.210 | 3.0 | — | n.a. | 1.4 + 0.7 | 0.7 |
| 6.1 | CMC | HCl | 0.625 | added to pH 3 | — | — | 3.0 | 2.1 | — |
| 6.2 | CMC | HCl | 0.625 | added to pH 4 | — | — | 4.0 | 2.2 | — |
| 6.3 | CMC | HCl | 0.625 | added to pH 5 | — | — | 5.0 | 2.2 | — |
| 6.4 | CMC | HCl | 0.625 | added to pH 6 | — | — | 6.0 | 2.2 | — |

n.a. = not available

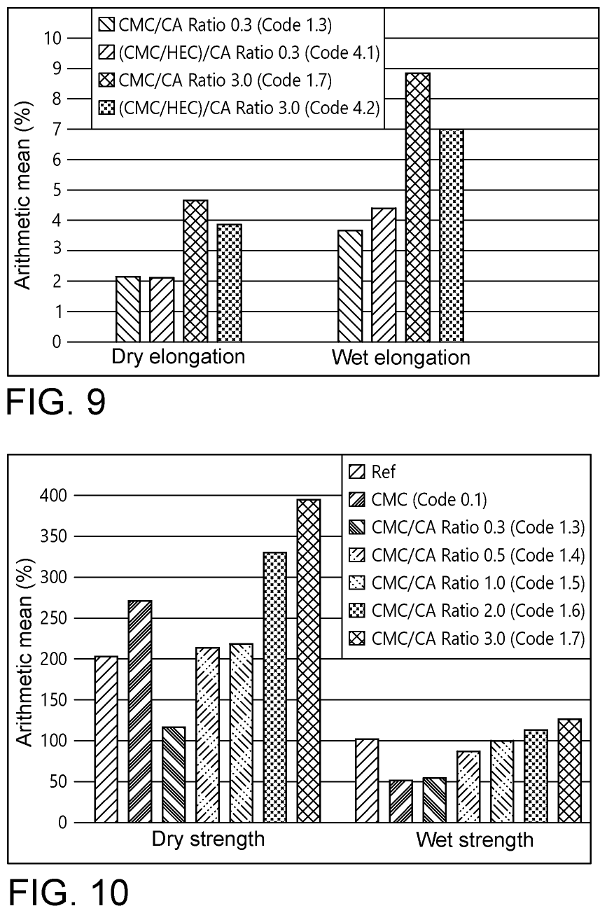

FIG. 10 illustrates the results from a comparison of dry and wet tensile strength of a fibrous material consolidated with CMV and CA with different CMC/CA ratios.

A surprising result from table 4 and FIGS. 8 and 10 is that the mechanical strength, both dry and wet, of the material is increased as the level of carboxylic acid in the binder solution is decreased.

Table 4 below illustrates further characteristics of the samples illustrated in table 3 above. As may be seen in Table 4, the water absorption capacity and absorption time are less affected by the different ratios of CMC and citric acid than the mechanical strength. It is easy to obtain an acceptable level of capacity and an acceptable time, quite independent of the amount of citric acid in the binder.

TABLE 4

| | | | | | Ratio | | | |
|---|---|---|---|---|---|---|---|---|
| | Binder system | | Add-on [wt-%] | | Binder | | | |
| | Binder | | Binder | | polymer/ | | Grammage | Thickness |
| Code | polymer | Acid | polymer | Acid | Acid | Additive | [g/m2] | [mm] |
| Ref | Elite 25 | — | 8.5 | — | — | — | 67.4 | 1.40 |
| 0.1 | CMC | CA | 2.3 | — | — | — | 65.5 | 1.41 |
| 1.1 | CMC | CA | 4.1 | 8.1 | 0.5 | — | 60.4 | 1.75 |
| 1.2 | CMC | CA | 4.3 | 2.2 | 2.0 | — | 58.6 | 1.99 |
| 1.3 | CMC | CA | 2.2 | 6.6 | 0.3 | — | 59.6 | 1.68 |
| 1.4 | CMC | CA | 2.3 | 4.7 | 0.5 | — | 61.1 | 1.59 |
| 1.5 | CMC | CA | 2.4 | 2.4 | 1.0 | — | 60.0 | 1.55 |
| 1.6 | CMC | CA | 2.4 | 0.2 | 2.0 | — | 60.0 | 1.72 |
| 1.7 | CMC | CA | 2.3 | 0.8 | 3.0 | — | 58.1 | 1.83 |
| 1.8 | CMC | CA | 2.3 | 6.6 | 0.3 | GLY* | 63.3 | 1.89 |
| 1.9 | CMC | CA | 2.4 | 0.8 | 3.0 | GLY* | 58.5 | 1.96 |
| 1.10 | CMC | CA | 2.4 | 0.8 | 3.0 | GLY ** | 66.1 | 1.57 |
| 3.1 | HEC | CA | 1.1 | 3.3 | 0.3 | — | 57.9 | 1.74 |
| 3.2 | HEC | CA | 1.2 | 0.4 | 3.0 | — | 60.9 | 1.77 |
| 4.1 | CMC + HEC | CA | 1.4 + 0.7 | 6.4 | 0.3 | — | 71.1 | 1.71 |
| 4.2 | CMC + HEC | CA | 1.4 + 0.7 | 0.7 | 3.0 | — | 65.6 | 1.65 |
| 6.1 | CMC | HCl | 2.1 | added to pH 3 | — | — | 63.6 | 1.51 |
| 6.2 | CMC | HCl | 2.2 | added to pH 4 | — | — | 62.0 | 1.45 |
| 6.3 | CMC | HCl | 2.2 | added to pH 5 | — | — | 64.4 | 1.44 |
| 6.4 | CMC | HCl | 2.2 | added to pH 6 | — | — | 63.5 | 1.44 |

| | Dry | Dry | Wet | Wet | | | |
|---|---|---|---|---|---|---|---|
| | strength | elongation | strength | elongation | | Absorption | Absorption |
| | Arithmetic | Arithmetic | Arithmetic | Arithmetic | Thickness | time | capacity |
| Code | mean [N/m] | mean [%] | mean [N/m] | mean [%] | [mm] | [s] | [g/g] |
| Ref | 204 | 7.8 | 104 | 12.8 | 1.40 | 3.0 | 15 |
| 0.1 | 270 | 4.5 | 53 | 8.0 | 1.41 | 1.6 | 14.0 |
| 1.1 | 283 | 2.3 | 150 | 4.0 | 1.75 | 3.3 | 15.0 |
| 1.2 | 567 | 4.5 | 227 | 7.8 | 1.99 | 2.1 | 14.6 |
| 1.3 | 117 | 2.2 | 56 | 3.6 | 1.68 | 2.6 | 17.9 |
| 1.4 | 215 | 2.5 | 87 | 4.2 | 1.59 | 1.9 | 15.9 |
| 1.5 | 217 | 3.2 | 98 | 5.5 | 1.55 | 1.9 | 14.7 |
| 1.6 | 335 | 3.8 | 114 | 7.5 | 1.72 | 1.8 | 16.6 |
| 1.7 | 395 | 4.7 | 126 | 9.0 | 1.83 | 1.6 | 17.5 |
| 1.8 | 143 | 2.4 | 74 | 4.9 | 1.89 | 3.7 | 16.8 |
| 1.9 | 461 | 5.0 | 184 | 10.1 | 1.96 | 1.7 | 16.3 |
| 1.10 | 359 | 4.5 | 120 | 8.9 | 1.57 | 1.6 | 14.0 |
| 3.1 | 130 | 2.4 | 53 | 5.0 | 1.74 | 1.7 | 16.0 |
| 3.2 | 96 | 4.5 | 36 | 8.7 | 1.77 | 2.0 | 16.0 |
| 4.1 | 185 | 2.1 | 80 | 4.4 | 1.71 | 1.4 | 15.0 |
| 4.2 | 325 | 3.9 | 111 | 7.0 | 1.65 | 1.4 | 14.5 |
| 6.1 | 279 | 4.4 | 90 | 8.6 | 1.51 | 1.6 | 14.2 |
| 6.2 | 310 | 4.8 | 80 | 10.0 | 1.45 | 1.6 | 14.6 |
| 6.3 | 354 | 5.2 | 85 | 9.9 | 1.44 | 1.7 | 14.6 |
| 6.4 | 543 | 5.7 | 89 | 8.5 | 1.44 | 1.5 | 14.4 |

n.a. = not available
*The mass of glycerol in solution is 10% of the mass of CMC
** The mass of glycerol in solution is 40% of the mass of CMC

1. A method for consolidating a fibrous material comprising plant-based fibers, the method comprising the steps of:
applying to the fibrous material an aqueous solution comprising a cellulose derivative, and/or a salt thereof, and an acid, the aqueous solution having a pH within the range of from 3 to 7; and
drying the bonded fibrous material.

2. The method according to claim 1, wherein the cellulose derivative, and/or a salt thereof, is carboxymethyl cellulose and/or sodium carboxymethyl cellulose.

3. The method according to claim 1, where the fibrous material is an airlaid, wetlaid, foam formed or carded nonwoven material comprising plant-based fibers.

4. The method according to claim 1, wherein the acid is a monoprotic acid.

5. The method according claim 1, wherein the aqueous solution furthermore comprises a pH control agent.

6. The method according to claim 1, wherein the acid is carboxylic acid.

7. The method according to claim 6, wherein the carboxylic acid is a monocarboxylic acid.

8. The method according to claim 6, wherein the carboxylic acid is a polycarboxylic acid.

9. The method according claim 1, wherein the method comprises the step of adding a bio-based plasticizer to the fibrous material.

10. The method according to claim 1, wherein a ratio of the cellulose derivative, and/or a salt thereof, and the acid is from 1.2:1.

11. The method according to claim 1, wherein the amount of acid is within the range of from 0.01 wt-% to 3 wt-% of the aqueous binder solutions total mass.

12. The method according to claim 1, wherein the amount of cellulose derivative, and/or a salt thereof, is within the range of from 0.4 wt-% to 6 wt-% of the aqueous binder solutions total mass.

13. The method according to claim 1, wherein the cellulose derivative, and/or a salt thereof, has a degree of substitution of from 0.65 to 1.

14. The method according to claim 1, wherein the aqueous solution is applied by spraying or coating.

15. A fibrous material obtained by the method according to claim 1.

16. An aqueous binder solution comprising a cellulose derivative, and/or a salt thereof, and an acid, the aqueous solution having a pH within the range of from 3 to 7.

17. The aqueous binder solution according to claim 16, wherein the cellulose derivative, and/or a salt thereof, is carboxymethyl cellulose and/or sodium carboxymethyl cellulose.

18. The aqueous binder solution according to claim 16, wherein the acid is a carboxylic acid.

19. The aqueous binder solution according to claim 16, wherein the aqueous solution furthermore comprises a pH control agent.

20. The aqueous binder solution according to claim 16, wherein a ratio of the cellulose derivative, and/or a salt thereof, and the acid is from 1.2:1.

21. The aqueous binder solution according to claim 16, wherein the amount of acid is within the range of from 0.2 wt-% to 3 wt-% of the aqueous binder solution total mass.

22. A nonwoven material comprising plant-based fibers, the plant-based fibers being consolidated together by a bio-based binder in presence of a carboxylic acid, the bio-based binder being a cellulose derivative, and/or a salt thereof, wherein the nonwoven has a pH within the range of from 3.5 to 5.5, as measured with the method as disclosed herein.

23. A nonwoven material comprising plant-based fibers, the plant-based fibers being consolidated together by a bio-based binder in presence of a carboxylic acid, the bio-based binder being a cellulose derivative, and/or a salt thereof, the nonwoven having a wet maximum tensile strength in machine direction (MD) of 100 N/m or more, and wet maximum tensile strength in cross direction (CD) of 100 N/m or more, as measured according to NWSP 110.4R0 (15).

24. The nonwoven material according to claim 22, wherein the plant-based fibers are cellulosic fibers and/or polylactic acid fibers.

25. The nonwoven material according to claim 22, wherein the nonwoven material is an airlaid nonwoven material.

26. The nonwoven material according to claim 22, wherein the carboxylic acid is any one of lactic acid, salicylic acid and/or citric acid.

27. The nonwoven material according to claim 22, wherein the carboxylic acid is a monocarboxylic acid.

28. The nonwoven material according t claim 22, wherein the nonwoven material has a wet elongation in machine direction (MD) of at least 6%, and a wet elongation in cross direction (CD) of at least 6%, as measured by a tensile tester according to NWSP 110.4R0 (15).
